(19) United States
(12) Patent Application Publication
(10) Pub. No.: US 2022/0064830 A1
(43) Pub. Date: Mar. 3, 2022

(54) THREE-DIMENSIONAL INTERLAYER COMPOSITE CARPET

(71) Applicant: KUNSHAN YIJIAJU TEXTILE CO., LTD., Kunshan (CN)

(72) Inventor: Cao SHUN LIN, Kunshan (CN)

(21) Appl. No.: 17/100,550

(22) Filed: Nov. 20, 2020

(30) Foreign Application Priority Data
Sep. 2, 2020 (CN) 202010910768.8

(51) Int. Cl. D04B 21/16; B32B 5/02

(52) U.S. Cl. CPC D04B 21/16; B32B 5/026; B32B 2471/02; D10B 2331/04; D10B 2403/021

(57) ABSTRACT

A three-dimensional interlayer composite carpet that can be washed without deformation is provided in the present invention, which includes a surface layer, a three-dimensional interlayer, and an anti-slip layer. The three-dimensional interlayer is composed of an upper knitted fabric layer, a lower knitted fabric layer, and a composite filament connecting layer arranged vertically in the middle and connecting the upper layer and the lower layer. The three-dimensional interlayer composite carpet adopting a composite filament connecting structure of the present invention has strong supporting force and high extensibility, and can be repeatedly folded for more than 1000 times. The washing shrinkage of 10 washings does not exceed 2%, and the composite carpet will not be deformed under long-term squeezing, heat, and moisture.

### CROSS-REFERENCE

The present application claims priority to Chinese Patent Application No. 202010910768.8 filed on Sep. 2, 2020, the entirety of which is incorporated herein by reference.

### TECHNICAL FIELD

The present invention relates to carpets in the textile industry, and in particular, to a three-dimensional interlayer composite carpet that can be washed without deformation.

### BACKGROUND

The 3D inter-mesh fabric currently available in the market is a double-needle-bed warp-knitted mesh fabric, which is composed of a mesh surface, connecting monofilaments, and a plain fabric bottom surface, forming its three-dimensional mesh fabric structure. The middle connecting layer may have various shapes, including a tubular shape, a pleated shape, and other shapes, which makes this three-layer fabric have a very broad application prospect. Usually, filaments of the upper and lower surfaces are polyester monofilaments, and the middle connecting filaments are also polyester monofilaments.

At present, household carpets basically cannot be cleaned, and some washable carpets can be dry-cleaned. The weight is more than 9 kilograms, and a washing machine cannot bear it. Furthermore, a carpet is too large to be put into a washing machine, which is one of the main reasons why families do not want to use carpets. However, carpets applying 3D mesh fabrics used on the market will deform under long-term squeezing, heat, and moisture, resulting in a short service life. Moreover, during the washing process when the ordinary 3D mesh fabric is folded and put into a washing machine or a sink, under the action of water flow, mechanical frictions, and temperature, monofilament fibers in the middle connecting layer will be irregularly inclined, resulting in depressions on the surface, which is easy to produce wrinkles. The edges cannot be flushed with the ground, and it is difficult to lay the carpet, which creates the risk of people tripping.

Therefore, there is a need for an environmentally-friendly and fully recyclable carpet that not only has the functions of a conventional carpet, but also facilitates a user to fold and wash at will without being deformed, thereby prolonging the service life of the carpet.

Through searching existing patent documents, it is found that a composite carpet with a breathable structure is disclosed in the Chinese utility model patent with application number 201220471847.4, which includes a carpet body, and the carpet body is divided into a three-layer structure from the surface layer to the bottom layer. The middle layer is a sponge layer, and the surface and bottom layers are both mesh fabric layers. This kind of carpets must be used in combination with a base layer through connection, which is costly and inconvenient to use. Moreover, the combination between the base layer and the connecting layer is easily loose to cause sliding risks. In addition, after this carpet is folded and put into a washing machine, obvious wrinkles will be generated and the carpet cannot be flushed with the ground. After washing, the middle sponge layer will increase the weight of the carpet due to the strong water absorption of the sponge, making the washing machine unable to bear its weight. Moreover, when a person walks on this kind of carpets, the monofilaments connecting the top surface and the bottom surface of the base layer rub against one other, which generates uncomfortable noises.

### SUMMARY OF THE INVENTION

The purpose of the present invention is to provide a three-dimensional interlayer composite carpet that can be washed without deformation. An anti-slip layer of the composite carpet can be folded arbitrarily and washed, and will not easily deformed when using elastic materials or fabrics less than 1 kg/m² and having the thickness not greater than 2 cm. It can meet the current needs of people to fold the carpet and put into a washing machine.

The purpose of the present invention is achieved through the following technical solutions.

The present invention relates to a three-dimensional interlayer composite carpet that can be washed without deformation, which includes a surface layer, a three-dimensional interlayer, and an anti-slip layer; wherein the three-dimensional interlayer is composed of an upper layer, a lower layer, and a composite filament connecting layer vertically arranged in the middle and connecting the upper layer and the lower layer.

As an embodiment of the present invention, in the composite filament connecting layer, the composite filaments connecting the upper layer and the lower layer are polyester, polypropylene, or nylon composite filaments.

As an embodiment of the present invention, in the composite filament connecting layer, the composite filaments connecting the upper layer and the lower layer are 48 D to 1200 D.

As an embodiment of the present invention, the three-dimensional interlayer has a thickness of 1.5 mm to 5 mm.

As an embodiment of the present invention, the upper layer and the lower layer are each a knitted fabric layer.

As an embodiment of the present invention, the knitted fabric layer is a monofilament knitted fabric layer (the knitted fabric is composed of monofilaments).

As an embodiment of the present invention, the monofilaments are 20 D-100 D polyester, polypropylene, or nylon monofilaments.

As an embodiment of the present invention, the anti-slip layer has a thickness of 0.1 mm to 20 mm.

As an embodiment of the present invention, the anti-slip layer is a thermoplastic elastomer layer (TPE, TPU, or TPR), a hot melt adhesive layer, a plastic dot cloth, a PVC mesh fabric, a styrofoam layer, or an EVA layer, or other fabrics with an anti-slip function.

As an embodiment of the present invention, the three-dimensional interlayer is an integrated structure.

As an embodiment of the present invention, the three-dimensional interlayer is an integrated structure woven by monofilaments of the upper and lower layers and composite filaments connecting the upper and lower layers through a double-needle-bed warp-knitting machine.

As an embodiment of the present invention, the three-dimensional interlayer is obtained by weaving into an integrated structure and then shaped at a high temperature of 80° C. to 230° C. The three-dimensional interlayer is formed from an upper layer, a lower layer, and a composite filament connecting layer arranged vertically in the middle and connecting the upper layer and the lower layer, which are shaped at a high temperature of 80° C. to 230° C. Specifically, the three-dimensional interlayer is an integrated structure woven by a double-needle-bed warp-knitting machine using 48 D-1200 D composite filaments and 20 D-100 D monofilaments and shaped at a high temperature of 80° C. to 230° C.

As an embodiment of the present invention, the surface layer is a carpet surface layer, or is a surface layer composited by a carpet surface and a functional fabric located between the carpet surface and the three-dimensional interlayer. Preferably, the functional fabric is a waterproof and breathable membrane.

Compared with the prior art, the present invention has the following beneficial effects:

1. The three-dimensional interlayer composite carpet with a composite filament connecting layer structure of the present invention has strong supporting force and high extensibility, and can be repeatedly folded for more than 1000 times; and the washing shrinkage of 10 washings does not exceed 2%.

2. The three-dimensional interlayer composite carpet with a composite filament connecting layer structure of the present invention will not be deformed under long-term squeezing, heat, and moisture.

3. For the three-dimensional interlayer composite carpet with a composite filament connecting layer structure of the present invention, the composite filaments in the composite filament connecting layer are not irregularly inclined after being washed for 10 times, and the surface of the carpet has no obvious depressions or wrinkles.

4. The composite carpet of the present invention can be provided with fabric with an anti-slip function under the three-dimensional interlayer to serve as an anti-slip layer, which has a strong anti-slip function, and also has the functions of protecting the ground and enhancing sound insulation.

### BRIEF DESCRIPTION OF THE DRAWINGS

By reading the detailed description of the non-limiting embodiments with reference to the following drawings, other features, purposes, and advantages of the present invention will become more apparent.

FIG. 1 is a schematic diagram of a structure of a three-dimensional interlayer;

FIG. 2 is a schematic diagram of a structure of a cut pile three-dimensional interlayer composite carpet;

FIG. 3 is a schematic diagram of a structure of a loop pile three-dimensional interlayer composite carpet;

FIG. 4 is a schematic diagram of a structure of a plain weave three-dimensional interlayer composite carpet; and

FIG. 5 is a schematic diagram of a structure adding a functional fabric between a carpet surface and a three-dimensional interlayer;

wherein 1 denotes an upper knitted fabric layer, 2 denotes a composite filament connecting layer, 3 denotes a lower knitted fabric layer, 4 denotes a cut pile layer, 5 denotes a base fabric layer, 6 denotes an anti-slip layer, 7 denotes a loop pile layer, and 8 denotes a plain weave fabric layer, and 9 denotes a functional fabric.

### DETAILED DESCRIPTION

Hereinafter, the present invention will be described in detail with reference to the embodiments. The following embodiments will help those skilled in the art to further understand the present invention, but do not limit the present invention in any form. It should be pointed out that for those of ordinary skill in the art, several adjustments and improvements can be made without departing from the concept of the present invention, and these all belong to the protection scope of the present invention.

### Embodiment 1

This embodiment relates to a three-dimensional interlayer composite carpet as shown in FIG. 3, which includes:

a surface layer composed of loop pile layer 7 and base fabric layer 5, a three-dimensional interlayer composed of upper knitted fabric layer 1, composite filament connecting layer 2, and lower knitted fabric layer 3, and anti-slip layer 6.

In the surface layer, the suede surface is made by weaving 2400 D plied yarns on a long-fiber base fabric using the tufting and looping process, and the pile height is 5 mm.

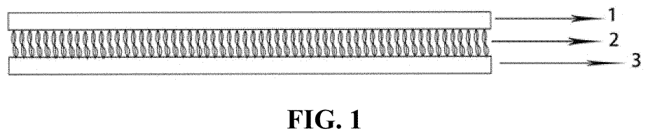

The three-dimensional interlayer, as shown in FIG. 1, is composed of upper knitted fabric layer 1, lower knitted fabric layer 3, and composite filament connecting layer 2 vertically arranged in the middle and connecting the upper layer and the lower layer. The three-dimensional interlayer has a thickness of 5 mm. The warp and weft density of the knitted fabric on the upper and lower layers of the three-dimensional interlayer is 3 mm×3 mm.

In this embodiment, a double-needle-bed warp-knitting machine adopts a threading method of 2 threading needles and 8 empty needles for weaving. The upper and lower surface materials are 30 D polyester monofilaments, and the materials arranged vertically in the middle and connecting the upper and lower layers are polyester DTY composite filaments in the specification of 300 D/576 F (i.e., composite filaments each having a thickness of 300 D and combined by 576 monofilaments). The two materials are woven together into a three-dimensional interlayer fabric. The three-dimensional interlayer fabric is shaped at a high temperature of 160° C., the shrinkage becomes smaller, but at the same time the elasticity is maintained.

A water-resistant PUR hot melt adhesive is used for bonding between the surface layer and the three-dimensional interlayer.

The anti-slip layer is an SEBS hot melt adhesive layer. Specifically, the SEBS hot melt adhesive is used for composite anti-slip treatment on the bottom of the three-dimensional interlayer. The anti-slip layer has a thickness of 0.1 mm and a glue amount of 20 g/m².

### Embodiment 2

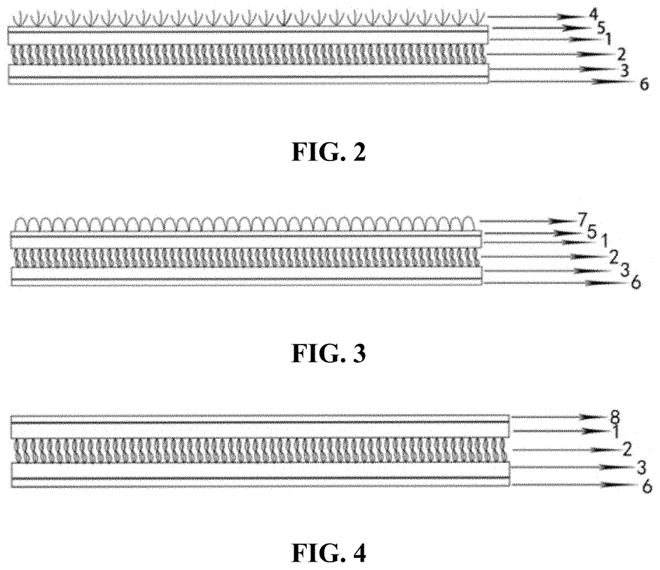

This embodiment relates to a three-dimensional interlayer composite carpet as shown in FIG. 2, which includes:

a surface layer composed of cut pile layer 4 and base fabric layer 5, a three-dimensional interlayer composed of upper knitted fabric layer 1, composite filament connecting layer 2, and lower knitted fabric layer 3, and anti-slip layer 6.

In the surface layer, the suede surface is made by weaving polyester 1200 D plied yarns on a PP network filament base fabric using the tufting and cutting process, and the pile height is 6 mm.

The three-dimensional interlayer has a thickness of 3 mm. The warp and weft density of the knitted fabric on the upper and lower layers of the three-dimensional interlayer is 3 mm×2.5 mm.

In this embodiment, a double-needle-bed warp-knitting machine adopts a threading method of 3 threading needles and 6 empty needles for weaving. The upper and lower surface materials are 60 D polyester monofilaments, and the materials arranged vertically in the middle and connecting the upper and lower layers are polyester composite filaments in the specification of 150 D/144 F (i.e., composite filament each having a thickness of 150 D and combined by 144 monofilaments). The two materials are woven together into a three-dimensional interlayer. The three-dimensional interlayer is shaped at a high temperature of 180° C., the shrinkage becomes smaller, but at the same time the elasticity is maintained.

The surface layer and the three-dimensional interlayer are composited by the TPE coating process.

The anti-slip layer is a TPE layer. Specifically, the coating process is used to melt the TPE of SHORE 45° C. and coat it on the bottom of the three-dimensional interlayer to form an anti-slip layer. The anti-slip layer has a thickness of 0.5 mm and a glue amount of 350 g/m².

### Embodiment 3

This embodiment relates to a three-dimensional interlayer composite carpet as shown in FIG. 4, which includes:

a surface layer (plain woven fabric layer 8, which may also be knitted fabric layer), a three-dimensional interlayer composed of upper knitted fabric layer 1, composite filament connecting layer 2, and lower knitted fabric layer 3, and anti-slip layer 6.

In the surface layer, the plain woven fabric layer can be woven by the woven jacquard chenille fabric weaving process.

The three-dimensional interlayer has a thickness of 2 mm. The warp and weft density of the knitted fabric on the upper and lower layers of the three-dimensional interlayer is 3 mm×2.5 mm.

In this embodiment, a double-needle-bed warp-knitting machine adopts a threading method of 4 threading needles and 8 empty needles for weaving. The upper and lower surface materials are 20 D polyester monofilaments, and the materials arranged vertically in the middle and connecting the upper and lower layers are polyester composite filaments in the specification of 300 D/96 F (i.e., composite filaments each having a thickness of 300 D and combined by 96 monofilaments). The two materials are woven together to form a three-dimensional interlayer. The three-dimensional interlayer is shaped at a high temperature of 120° C., the shrinkage becomes smaller, but at the same time the elasticity is maintained.

The woven fabric layer and the three-dimensional interlayer are composited by the TPE coating process.

The anti-slip layer is plastic dot non-woven fabric layer 5. Specifically, the coating process is used to bond the plastic dot non-woven fabric with the bottom of the three-dimensional interlayer. The anti-slip layer has a thickness of 3 mm.

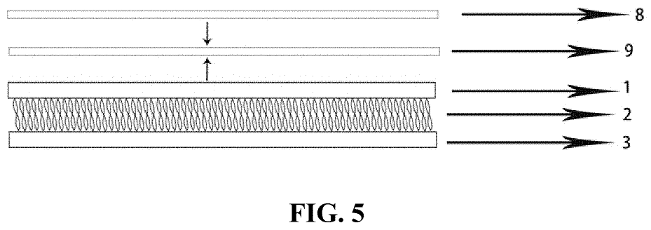

As a variation of this embodiment, as shown in FIG. 5, the surface layer is composed of plain woven fabric layer 8 and functional fabric 9. Functional fabric 9 adopts a waterproof and breathable membrane, which is bonded between plain woven fabric layer 8 and upper knitted fabric layer 1 of the three-dimensional interlayer by hot melt adhesive.

### Comparative Example 1

This comparative example relates to a three-dimensional interlayer composite carpet, which is basically the same as that in Embodiment 2, only except that:

the three-dimensional interlayer is composed of an upper knitted fabric layer, a monofilament connecting layer, and a lower knitted fabric layer.

In this comparative example, a double-needle-bed warp-knitting machine adopts a threading method of 3 threading needles and 6 empty needles for weaving. The upper and lower surface materials are 60 D polyester monofilaments, and the materials arranged vertically in the middle and connecting the upper and lower layers are polyester monofilaments in the specification of 150 D. The two materials are woven together to form a three-dimensional interlayer. The three-dimensional interlayer is shaped at a high temperature of 180° C., the shrinkage becomes smaller, but at the same time the elasticity is maintained.

Performance Verification

1. Comparison and Verification of Washing Test

Experimental conditions: Take the following carpet with a size of 140×200 cm, wash it in a household washing machine with a power of 480 W for 30 minutes, dehydrate for 10 minutes, and test at a drying temperature of 70°.

According to the application number 201220471847.4, a composite carpet with a size of 140×200 cm is prepared. Since the middle layer is a sponge layer, the weight is increased after water absorption, and the washing machine cannot bear it. After being squeezed and soaked in water, the monofilaments in the middle are irregularly inclined, resulting in depressions and wrinkles on the surface. After being soaked in water, the shrinkage after drying in a wet state is 2.5%.

Take the composite carpet of Comparative Example 1 with a size of 140×200 cm. After washing, it is found that the monofilaments of the three-dimensional interlayer are irregularly inclined, and slight depressions and wrinkles appear on the surface of the carpet and the back of the carpet. After washing, the shrinkage after drying in a wet state is 1.8%. The washing shrinkage after washing and drying are repeated 10 times is 2.06%. At this time, obvious depressions and wrinkles appear on the surface of the carpet and the back of the carpet. It takes 30 minutes to dry each time.

Take the loop pile three-dimensional interlayer composite carpet in Embodiment 1 with a size of 140×200 cm. After washing, there is no obvious depression on the surface and the back of the carpet, and the edges are flushed with the ground. After washing, the shrinkage after drying in a wet state is 1.25%. The washing shrinkage after washing and drying are repeated 10 times is 1.5%. At this time, there is still no obvious depression on the surface of the carpet and the back of the carpet, the edges are flushed with the ground, and the composite filaments in the three-dimensional interlayer are not inclined. It takes 30 minutes to dry each time.

Take the cut pile three-dimensional interlayer composite carpet in Embodiment 2 with a size of 140×200 cm. After washing, there is no obvious depression on the surface and the back of the carpet, and the edges are flushed with the ground. After washing, the shrinkage after drying in a wet state is 1.15%. The washing shrinkage after washing and drying are repeated 10 times is 1.4%. At this time, there is still no obvious depression on the surface of the carpet and the back of the carpet, the edges are flushed with the ground, and the composite filaments in the three-dimensional interlayer are not inclined. It takes 40 minutes to dry each time.

Take the woven chenille three-dimensional interlayer composite carpet in Embodiment 3 with a size of 140×200 cm. After washing, there is no obvious depression on the surface and the back of the carpet, and the edges are flushed with the ground. After washing, the shrinkage after drying in a wet state is 1.5%. The washing shrinkage after washing and drying are repeated 10 times is 1.95%. At this time, there is still no obvious depression on the surface of the carpet and the back of the carpet, the edges are flushed with the ground, and the composite filaments in the three-dimensional interlayer are not inclined. It takes 40 minutes to dry each time.

2. Comparison and Verification of Folding Effect

According to the application number 201220471847.4, a composite carpet with a size of 100×100 cm is prepared, and folded irregularly at an ambient temperature of 50 degrees and an ambient humidity of 90% (simulating the condition of sea transportation of cargo passing the equator) and pressed with a 50 KG weight at the fold. After 24 hours, the weight is removed and the carpet is flattened. There are obvious depressions and wrinkles on the surface and back of the carpet, and some areas of the bottom surface cannot be kept flat. After being flattened for 24 hours, some wrinkles are alleviated, but there are still obvious patches, depressions, and wrinkles on some areas of the surface of the carpet and the back of the carpet.

Take the composite carpet of Comparative Example 1 with a size of 100×100 cm. It is folded irregularly at an ambient temperature of 50 degrees and an ambient humidity of 90% (simulating the condition of sea transportation of cargo passing the equator) and pressed with a 50 KG weight at the fold. After 24 hours, the weight is removed and the carpet is flattened. There are obvious patches, depressions, and wrinkles on the surface and back of the carpet, and some areas of the bottom surface cannot be kept flat. After being flattened for 24 hours, some wrinkles are alleviated, but there are still obvious patches, depressions, and wrinkles on some areas of the surface of the carpet and the back of the carpet.

Take the loop pile three-dimensional interlayer composite carpet in Embodiment 1 with a size of 100×100 cm. It is folded irregularly at an ambient temperature of 50 degrees and an ambient humidity of 90% (simulating the condition of sea transportation of cargo passing the equator) and pressed with a 50 KG weight at the fold. After 24 hours, the weight is removed and the carpet is flattened. The surface rebounds quickly, with slight wrinkles and creases in some areas. The edges are slightly tilted from the ground. After being flattened for 24 hours, there is no obvious crease, wrinkle, or patch on the surface of the carpet and the back of the carpet. The edges are flushed with the ground.

Take the cut pile three-dimensional interlayer composite carpet in Embodiment 2 with a size of 100×100 cm. It is folded irregularly at an ambient temperature of 50 degrees and an ambient humidity of 90% (simulating the condition of sea transportation of cargo passing the equator) and pressed with a 50 KG weight at the fold. After 24 hours, the weight is removed and the carpet is flattened. The surface rebounds quickly, with slight wrinkles and creases in some areas. The edges are slightly tilted from the ground. After being flattened for 24 hours, there is no obvious crease or wrinkle on the surface, and the edges are flushed with the ground.

Take the woven jacquard chenille three-dimensional interlayer composite carpet in Embodiment 3 with a size of 100×100 cm. It is folded irregularly at an ambient temperature of 50 degrees and an ambient humidity of 90% (simulating the condition of sea transportation of cargo passing the equator) and pressed with a 50 KG weight at the fold. After 24 hours, the weight is removed and the carpet is flattened. The surface rebounds quickly, with slight wrinkles and creases in some areas. After being flattened for 24 hours, there is no obvious crease or wrinkle on the surface, and the edges are flushed with the ground.

In summary, a three-dimensional interlayer composite carpet that can be washed without deformation is provided in the present invention. Moreover, not limited to the above embodiments, the carpet surface layer of the composite carpet of the present invention can be fabrics woven by various processes, such as loop pile fabrics, cut pile fabrics, woven fabrics, knitted fabric layers, and other fabrics that can be used for carpets. The three-dimensional interlayer can be woven with 48 D-1200 D polyester composite filaments and 20-100 D monofilaments to produce a variety of patterns with strong supporting force and high extensibility. The bottom layer can be composited with thermoplastic elastomers (such as TPE, TPU, and EVA), hot melt adhesive, styrofoam, EVA, plastic dot cloth, and other anti-slip materials to improve the anti-slip function, elasticity, and sound insulation function of the composite carpet. Moreover, the surface layer, the three-dimensional interlayer, and the anti-slip layer can also be tightly combined by the hot pressing process through the use of thermoplastic elastomer materials (TPE, TPU, EVA, etc.), hot melt adhesives, and adhesive materials that are insoluble in water.

The specific embodiments of the present invention have been described above. It should be understood that the present invention is not limited to the above specific embodiments, and those skilled in the art can make various deformations or modifications within the scope of the claims, which does not affect the essential content of the present invention.

1. A three-dimensional interlayer composite carpet that can be washed without deformation, comprising a surface layer, a three-dimensional interlayer, and an anti-slip layer, wherein the three-dimensional interlayer is composed of an upper layer, a lower layer, and a composite filament connecting layer arranged vertically in the middle and connecting the upper layer and the lower layer.

2. The three-dimensional interlayer composite carpet that can be washed without deformation according to claim 1, wherein in the composite filament connecting layer, the composite filaments connecting the upper layer and the lower layer are polyester, polypropylene, or nylon composite filaments.

3. The three-dimensional interlayer composite carpet that can be washed without deformation according to claim 1, wherein in the composite filament connecting layer, the composite filaments connecting the upper layer and the lower layer are 48 D to 1200 D.

4. The three-dimensional interlayer composite carpet that can be washed without deformation according to claim 1, wherein the three-dimensional interlayer has a thickness of 1.5 mm to 5 mm.

5. The three-dimensional interlayer composite carpet that can be washed without deformation according to claim 1, wherein the upper layer and the lower layer are each a monofilament knitted fabric layer; and the monofilaments are 20 D-100 D polyester, polypropylene, or nylon monofilaments.

6. The three-dimensional interlayer composite carpet that can be washed without deformation according to claim 1, wherein the surface layer is a surface layer composited by a carpet surface and a functional fabric, and the functional fabric is located between the carpet surface and the three-dimensional interlayer.

7. The three-dimensional interlayer composite carpet that can be washed without deformation according to claim 1, wherein the anti-slip layer has a thickness of 0.1 mm to 20 mm.

8. The three-dimensional interlayer composite carpet that can be washed without deformation according to claim 7, wherein the anti-slip layer is a thermoplastic elastomer layer, a hot melt adhesive layer, a plastic dot cloth, a PVC mesh fabric, a styrofoam layer, or an EVA layer.

9. The three-dimensional interlayer composite carpet that can be washed without deformation according to claim 1, wherein the three-dimensional interlayer is an integrated structure.

10. The three-dimensional interlayer composite carpet that can be washed without deformation according to claim 1, wherein the three-dimensional interlayer is woven by monofilaments of the upper and lower layers and composite filaments connecting the upper and lower layers through a double-needle-bed warp-knitting machine and then shaped at a high temperature of 80° C. to 230° C.
